(19) United States
(12) Patent Application Publication
(10) Pub. No.: US 2023/0168221 A1
(43) Pub. Date: Jun. 1, 2023

(54) GAS SENSOR AND SENSOR ELEMENT

(71) Applicant: NGK INSULATORS, LTD., Nagoya (JP)

(72) Inventor: Ryo ONISHI, Iwakura (JP)

(21) Appl. No.: 18/058,490

(22) Filed: Nov. 23, 2022

(30) Foreign Application Priority Data
Nov. 29, 2021 (JP) 2021-192898

(51) Int. Cl. G01N 27/407; G01N 27/41

(52) U.S. Cl. CPC G01N 27/4077; G01N 27/41; G01N 27/4071

(57) ABSTRACT

A gas sensor includes a sensor element and a contact metal fitting. The sensor element has an element body having an oxygen-ion-conductive solid electrolyte layer; an upper connector electrode disposed outside the element body; a lead disposed outside the element body and electrically conductive to the upper connector electrode; and a first protection layer that covers the lead, where a thickness T1 of a portion covering the lead is 2 µm or more, a porosity P1 is 20% or less, and a height difference D1 relative to the upper connector electrode is 22 µm or less. The contact metal fitting has: a conduction member that projects to the upper connector electrode and is in contact with and electrically conducted to the upper connector electrode; and a support member that projects toward the lead and is in contact with the first protection layer.

### CROSS-REFERENCE TO RELATED APPLICATION

The present application claims priority from Japanese Patent Application No. 2021-192898, filed on Nov. 29, 2021, the entire contents of which are incorporated herein by reference.

### BACKGROUND OF THE INVENTION

### 1. Field of the Invention

The present invention relates to a gas sensor and a sensor element.

### 2. Description of the Related Art

A known gas sensor in the related art detects the concentration of a specific gas, such as NOx, in measurement-object gas, such as exhaust gas of an automobile. For example, the gas sensor in PTL1 includes a sensor element, and a contact metal fitting electrically connected to an electrode provided on the surface of the sensor element. The contact metal fitting is an elongated member produced by bending metal, and includes a support member and a conduction member which project to the sensor element. When the contact metal fitting is pressed against the sensor element, the support member is brought into contact with the surface of the sensor element as well as the conduction member is brought into contact with the electrode of the sensor element. Thus, electrical conduction between the sensor element and the contact member is maintained by the conduction member, and the contact of the support member with the sensor element prevents the sensor element from being cracked due to a pressing force from the conduction member.

### CITATION LIST

### Patent Literature

PTL 1: JP 2014-209104 A

### SUMMARY OF THE INVENTION

Meanwhile, a lead is connected to an electrode of a sensor element, and when the lead is disposed outside the sensor element, the lead may wear due to friction caused by contact between the lead and a support member of a contact metal fitting. To prevent this, an approach can be taken to protect against direct contact between the lead and the support member by covering the lead with a protection layer. However, when the lead is covered with a protection layer, electrical conduction between a conduction member and the electrode may be insufficient due to the thickness of the protection layer.

The present invention has been devised to solve the aforementioned problem, and a main object thereof is to reduce an occurrence of a conduction failure between a connector electrode and a contact metal fitting while protecting the lead from wear.

In order to achieve the aforementioned main object, the present invention employs the following solutions.

The gas sensor of the present invention provides a gas sensor that detects a specific gas concentration in a measurement-object gas, the gas sensor comprising: a sensor element including: an element body having an oxygen-ion-conductive solid electrolyte layer, a connector electrode disposed outside the element body, a lead disposed outside the element body and electrically conductive to the connector electrode, and a protection layer that covers the lead, where a thickness T1 of a portion covering the lead is 2 µm or more, a porosity P1 is 20% or less, and a height difference D1 relative to the connector electrode is 22 µm or less; and a contact metal fitting including: a conduction member that projects to the connector electrode and is in contact with and electrically conducted to the connector electrode, and a support member that projects toward the lead and is in contact with the protection layer.

In this gas sensor, the porosity P1 of a protection layer provided between the lead and the support member is 20% or less, and the thickness T1 of the portion, covering the lead, in the protection layer is 2 µm or more, thus the protection layer can protect the lead from the support member to avoid wear of the lead. Although the height difference D1 between the protection layer and the connector electrode tends to increase for a larger thickness T1, an occurrence of a conduction failure between the conduction member and the connector electrode can be reduced by setting the height difference D1 to 22 µm or less because due to the setting, the height of protection layer is not too high relative to the height of the connector electrode, which avoids insufficient contact between the conduction member and the connector electrode. Based upon the foregoing, in the gas sensor of the present invention, an occurrence of a conduction failure between the connector electrode and the contact metal fitting can be reduced while protecting the lead from wear. Here, the height difference D1 has a positive value when the height of the protection layer is higher than the height of the connector electrode. In other words, the height difference D1 is a value obtained by subtracting the height of the connector electrode from the height of the protection layer.

In the gas sensor of the present invention, the porosity P1 of the protection layer may be 10% or less. In this setting, the protection layer has an increased effect of protection of the lead from wear.

In the gas sensor of the present invention, the element body may have an elongate shape having a longitudinal direction, the conduction member and the support member of the contact metal fitting may be disposed in the longitudinal direction, and the protection layer may have a length L of 2 mm or more in the longitudinal direction. In this setting, even when the relative position of the protection layer with respect to the support member is displaced in the longitudinal direction, the protection layer is present between the support member and the lead, thus the state of protected lead is likely to be maintained. Thus, it is possible to protect the lead from wear due to direct contact between the support member and the lead.

In the gas sensor of the present invention, the height difference D2 obtained by subtracting the height of the connector electrode from the height of the lead may exceed 0 µm. When the height difference D2 exceeds 0 µm, in other words, when the lead is greater in height than the connector electrode, the height difference D1 is likely to increase because the protection layer is further provided on the lead. However, even in this case, with the height difference D1 of 22 µm or less, it is possible to reduce the occurrence of a conduction failure between the connector electrode and the contact metal fitting.

In the gas sensor of the present invention, the height difference D1 may be 4 µm or more. In the gas sensor of the present invention, the protection layer may be ceramic containing particles of at least one selected from the group of alumina and zirconia.

The sensor element of the present invention provides a sensor element that detects a specific gas concentration in a measurement-object gas, the sensor element comprising: an element body having an oxygen-ion-conductive solid electrolyte layer; a connector electrode disposed outside the element body; a lead disposed outside the element body and electrically conductive to the connector electrode; and a protection layer that covers the lead, where a thickness T1 of a portion covering the lead is 2 µm or more, a porosity P1 is 20% or less, and a height difference D1 relative to the connector electrode is 22 µm or less.

As in the sensor element of the above-described gas sensor, this sensor element includes a protection layer in which the porosity P1 is 20% or less, the thickness T1 of the portion covering the lead is 2 µm or more, and the height difference D1 relative to the connector electrode is 22 µm or less. Therefore, this sensor element is suitable for the sensor element to be used for the above-described gas sensor of the present invention. For example, when a contact metal fitting is attached to the sensor element, if the conduction member of the contact metal fitting is brought into conduction with the connector electrode and the support member of the contact metal fitting is brought into contact with the portion, covering the lead, in the protection layer, an occurrence of a conduction failure between the connector electrode and the contact metal fitting can be reduced while protecting the lead from wear. In this sensor element, various embodiments of the above-described gas sensor of the present invention may be implemented.

### BRIEF DESCRIPTION OF THE DRAWINGS

FIG. 1 is a vertical sectional view illustrating the manner in which a gas sensor 10 is mounted on a pipe 58.

FIG. 2 is a perspective view of a sensor element 20.

FIG. 3 is a cross-sectional view taken along line A-A in FIG. 2.

FIG. 4 is a top view of the sensor element 20.

FIG. 5 is a perspective view of a connector 50.

FIG. 6 is a cross-sectional view taken along line B-B in FIG. 5.

FIG. 7 is a perspective view of a contact metal fitting 52.

FIG. 8 is an explanatory view illustrating contact portions C1, C2 between the sensor element 20 and the contact metal fitting 52.

FIG. 9 is a partial enlarged view of a cross section along line C-C in FIG. 8.

FIG. 10 is a partial enlarged view of a cross section along line D-D in FIG. 8.

### DETAILED DESCRIPTION OF THE INVENTION

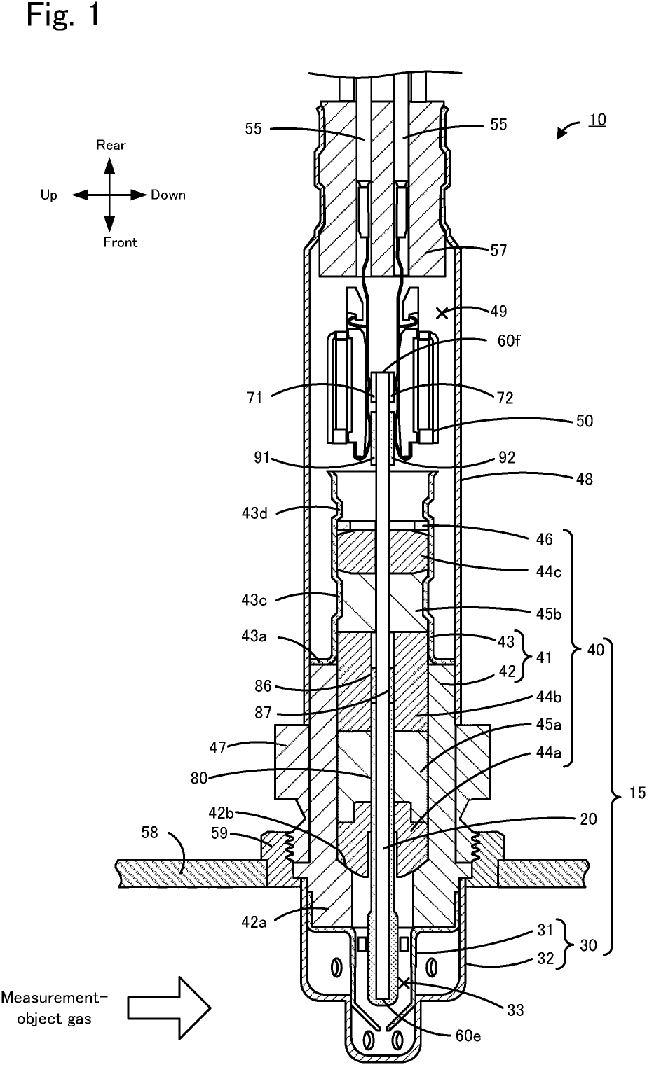

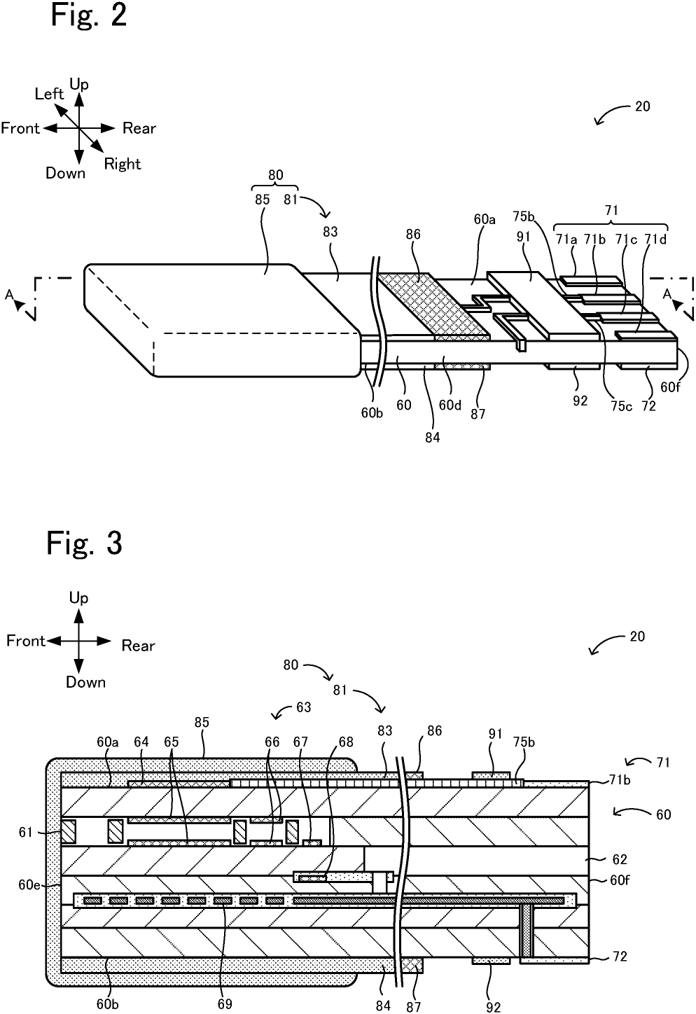

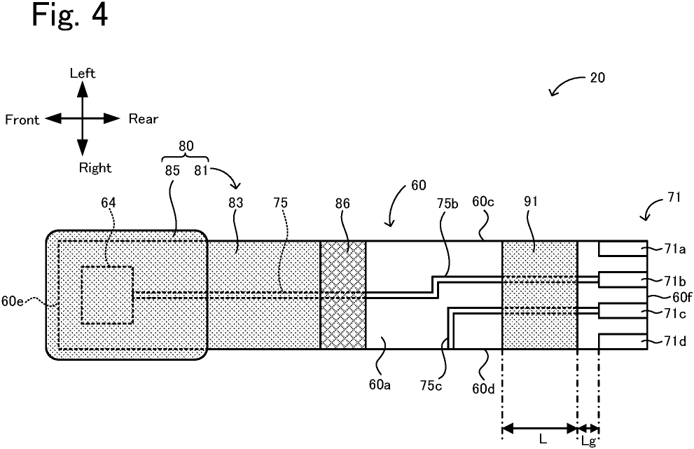

Next, embodiments of the present invention will be described with reference to the drawings. FIG. 1 is a vertical sectional view illustrating the manner in which a gas sensor 10 according to an embodiment of the present invention is attached to a pipe 58. FIG. 2 is a perspective view of a sensor element 20 as seen from an upper right forward position. FIG. 3 is a cross-sectional view taken along line A-A in FIG. 2. FIG. 4 is a top view of the sensor element 20. In this embodiment, as illustrated in FIGS. 2 and 3, it is assumed that the longitudinal direction of an element body 60 of the sensor element 20 is the front-rear direction (length direction), the stacking direction (thickness direction) of the element body 60 is the up-down direction, and the direction perpendicular to the front-rear direction and the up-down direction is the right-left direction (width direction).

As illustrated in FIG. 1, the gas sensor 10 includes an assembly 15, a bolt 47, an outer cylinder 48, a connector 50, lead wires 55, and a rubber stopper 57. The assembly 15 includes the sensor element 20, a protection cover 30, and an element sealing unit 40. The gas sensor 10 is attached to the pipe 58, such as an exhaust gas pipe of a vehicle, and is used for measuring the concentration (specific gas concentration) of a specific gas, such as NOx or O₂, contained in an exhaust gas as a measurement-object gas. In this embodiment, the gas sensor 10 measures the NOx concentration as the specific gas concentration. Of both ends (the front end, the rear end) of the sensor element 20 in the longitudinal direction, the front-end side is exposed to the measurement-object gas.

As illustrated in FIG. 1, the protection cover 30 includes a bottomed cylindrical inner protection cover 31 that covers the front-end side of the sensor element 20, and a bottomed cylindrical outer protection cover 32 that covers the inner protection cover 31. The inner, outer protection covers 31, 32 each have a plurality of holes for allowing the measurement-object gas to flow. An element chamber 33 is provided as a space surrounded by the inner protection cover 31, and a fifth face 60e (front-end face) of the sensor element 20 is disposed in the element chamber 33.

The element sealing unit 40 is a member that seals and fixes the sensor element 20. The element sealing unit 40 includes a cylindrical body 41 having a main metal fitting 42 and an inner cylinder 43, insulators 44a to 44c, green compacts 45a, 45b, and a metal ring 46. The sensor element 20 is located on the central axis of the element sealing unit 40 and extends through the element sealing unit 40 in the up-down direction.

The main metal fitting 42 is a cylindrical metal member. In the main metal fitting 42, the front side is a thick wall portion 42a with an inner diameter smaller than the inner diameter of the rear side. The protection cover 30 is attached to the same side (the front side) as the front end of the sensor element 20 of the main metal fitting 42. The rear end of the main metal fitting 42 is welded to a flange 43a of the inner cylinder 43. Part of the inner peripheral surface of the thick wall portion 42a is a bottom surface 42b which is a step surface. The bottom surface 42b presses against the insulator 44a to prevent it from coming forward.

The inner cylinder 43 is a cylindrical metal member, and has the flange 43a at the front end. The inner cylinder 43 and the main metal fitting 42 are coaxially welded and secured. In addition, the inner cylinder 43 is provided with a reduced-diameter section 43c for pressing the green compact 45b toward the central axis of the inner cylinder 43, and a reduced-diameter section 43d for pressing the insulators 44a to 44c, the green compacts 45a, 45b via the metal ring 46 in the down direction in FIG. 1.

The insulators 44a to 44c and the green compacts 45a, 45b are disposed between the inner peripheral surface of the cylindrical body 41 and the sensor element 20. The insulators 44a to 44c play a role as supporters for the green compacts 45a, 45b. The green compacts 45a, 45b are obtained, for example, by molding ceramic powder such as talc. The green compacts 45a, 45b are filled and compressed between the cylindrical body 41 and the sensor element 20, thus the green compacts 45a, 45b seal between the element chamber 33 in the protection cover 30 and a space 49 in the outer cylinder 48 as well as fix the sensor element 20.

The bolt 47 is secured to the outside of the main metal fitting 42 coaxially therewith. A male threaded section is formed on the outer peripheral surface of the bolt 47. The male threaded section is inserted into a securing member 59 having a female threaded section in the inner peripheral surface thereof and welded to the pipe 58. Accordingly, the gas sensor 10 is secured to the pipe 58 in a state where the front-end side of the sensor element 20 and part of the protection cover 30 of the gas sensor 10 protrude into the pipe 58.

The outer cylinder 48 is a cylindrical metal member, and covers the inner cylinder 43, the rear-end side of the sensor element 20, and the connector 50. The rear section of the main metal fitting 42 is inserted into the inside of the outer cylinder 48. The front end of the outer cylinder 48 is welded to the main metal fitting 42. A plurality of lead wires 55 connected to the connector 50 are routed outward from the rear end of the outer cylinder 48. The connector 50 is in contact with and electrically connected to an upper connector electrode 71 and a lower connector electrode 72 which are disposed on the surface on the rear-end side of the sensor element 20. The lead wires 55 are electrically conductive to electrodes 64 to 68 and a heater 69 inside the sensor element 20 via the connector 50. The details of the connector 50 will be described later. A gap between the outer cylinder 48 and the lead wires 55 is sealed by the rubber stopper 57. The space 49 in the outer cylinder 48 is filled with a reference gas. A sixth face 60f (rear end face) of the sensor element 20 is disposed in the space 49.

As illustrated in FIGS. 2 to 4, the sensor element 20 includes the element body 60, a detection unit 63, the heater 69, the upper connector electrode 71, the lower connector electrode 72, a porous layer 80, a first dense layer 86, a second dense layer 87, a first protection layer, and a second protection layer. The sensor element 60 has a layered body obtained by stacking multiple (six in FIG. 3) oxygen-ion-conductive solid electrolyte layers composed of, for example, zirconia (ZrO₂). The sensor element 60 has an elongate rectangular parallelepiped shape with the longitudinal direction in the front-rear direction, and has the first to sixth faces 60a to 60f as the outer faces on the upper, lower, right, left, front, and rear sides. The first to fourth faces 60a to 60d are the faces along the longitudinal direction of the sensor element 60, and correspond to the lateral faces of the element body 60. The fifth face 60e is the front-end face of the element body 60, and the sixth face 60f is the rear-end face of the element body 60. As the dimensions of the element body 60, for example, the length may be 25 mm or greater and 100 mm or less, the width may be 2 mm or greater and 10 mm or less, and the thickness may be 0.5 mm or greater and 5 mm or less. The element body 60 is provided with a measurement-object gas inlet 61 which is open in the fifth face 60e to introduce a measurement-object gas inwardly, and a reference gas inlet 62 which is open in the sixth face 60f to introduce a reference gas (in this case, atmospheric air) serving as a reference for detection of a specific gas concentration.

The detection unit 63 is for detecting a specific gas concentration in a measurement-object gas. The detection unit 63 has a plurality of electrodes disposed on the front-end side of the element body 60. In this embodiment, the detection unit 63 includes the outer electrode 64 disposed on the first face 60a, and the inner main pump electrode 65, the inner auxiliary pump electrode 66, the measurement electrode 67, and the reference electrode 68 which are disposed inside the element body 60. The inner main pump electrode 65 and the inner auxiliary pump electrode 66 are disposed on the inner peripheral surface of the space inside the element body 60, and have a tunnel-like structure.

The principle to detect a specific gas concentration in a measurement-object gas by the detection unit 63 is well-known, thus a detailed description is omitted. The detection unit 63 detects a specific gas concentration in a measurement-object gas, for example, as follows. The detection unit 63 pumps out or pumps in the oxygen in a measurement-object gas in a periphery of the inner main pump electrode 65 to or from the outside (the element chamber 33) based on the voltage applied across the outer electrode 64 and the inner main pump electrode 65. In addition, the detection unit 63 pumps out or pumps in the oxygen in a measurement-object gas in a periphery of the inner auxiliary pump electrode 66 to or from the outside (the element chamber 33) based on the voltage applied across the outer electrode 64 and the inner auxiliary pump electrode 66. Thus, a measurement-object gas with an oxygen concentration adjusted to a predetermined value reaches a periphery of the measurement electrode 67. The measurement electrode 67 functions as a NOx reduction catalyst, and reduces a specific gas (NOx) in the measurement-object gas reached. The detection unit 63 generates, as an electrical signal, an electromotive force occurring between the measurement electrode 67 and the reference electrode 68 according to an oxygen concentration after reduction or a current flowing between the measurement electrode 67 and the outer electrode 64 based on the electromotive force. The electrical signal generated in this manner by the detection unit 63 is a signal indicating a value (value by which a specific gas concentration is derivable) according to a specific gas concentration in a measurement-object gas, and corresponds to a detection value detected by the detection unit 63.

The heater 69 is an electrical resistor disposed inside the element body 60. The heater 69 generates heat by being supplied with electricity from the outside, and heats the element body 60. The heater 69 heats and maintains the temperature of the solid electrolyte layers constituting the element body 60, thereby making it possible to adjust the element body 60 to a temperature (for example, 800° C.) at which the solid electrolyte layers are activated.

The upper connector electrode 71 and the lower connector electrode 72 are disposed on the rear-end side of one of the lateral faces of the element body 60 to be electrically conductive to the outside. Each of the upper, lower connector electrodes 71, 72 is exposed to the outside of the sensor element 20. In this embodiment, four upper connector electrodes 71a to 71d are arranged as the upper connector electrode 71 in the right-left direction, and are disposed on the rear-end side of the first face 60a. Similarly, four electrodes are arranged as the lower connector electrode 72 in the right-left direction, and are disposed on the rear-end side of the second face 60b (the lower face) on the opposite side of the first face 60a (the upper face). Only part of the four electrodes in the lower connector electrode 72 is illustrated in FIGS. 1 to 3. The upper, lower connector electrodes 71, 72 are each electrically conductive to one of the plurality of electrodes 64 to 68 and the heater 69 of the detection unit 63. In this embodiment, the upper connector electrode 71a is conductive to the measurement electrode 67, the upper connector electrode 71b is conductive to the outer electrode 64, the upper connector electrode 71c is conductive to the inner auxiliary pump electrode 66, the upper connector electrode 71d is conductive to the inner main pump electrode 65, and four lower connector electrodes 72 are each conductive to the heater 69 and the reference electrode 68. The upper connector electrode 71b and the outer electrode 64 are conductive to each other via a lead 75b disposed on the first face 60a (see FIGS. 3 and 4). The upper connector electrode 71c and the inner auxiliary pump electrode 66 are conductive to each other via a lead 75c (see FIGS. 2 and 4) disposed on the first face 60a and the fourth face 60d and a lead disposed inside the element body 60. The connector electrodes other than these are each conductive to a corresponding electrode or the heater 69 via a lead or a through-hole disposed inside the element body 60.

The leads 75b, 75c are conductive materials containing noble metal such as platinum (Pt), and a high melting point metal, such as tungsten (W), molybdenum (Mo), for example. The leads 75b, 75c are each preferably a cermet conductor containing a noble metal or a high melting point metal, and an oxygen-ion-conductive solid electrolyte (zirconia in this embodiment) contained in the element body 60. In this embodiment, the leads 75b, 75c are each a cermet conductor containing platinum and zirconia. The porosity of the leads 75b, 75c may be, for example, 5% or more and 40% or less. The line width (thickness) of the leads 75b, 75c is, for example, 0.1 mm or more and 1.0 mm or less. An insulating layer (not illustrated) may be disposed between the leads 75b, 75c and the first face 60a of the element body 60 to insulate the leads 75b, 75c and the solid electrolyte layer of the element body 60.

The porous layer 80 is a porous body that covers at least front-end side of the lateral faces of the element body 60, on which the upper, lower connector electrodes 71, 72 are disposed, in other words, the first, second faces 60a, 60b. In this embodiment, the porous layer 80 includes an inner porous layer 81 that covers each of the first, second faces 60a, 60b, and an outer porous layer 85 disposed outside the inner porous layer 81.

The inner porous layer 81 includes a first inner porous layer 83 that covers the first face 60a, and a second inner porous layer 84 that covers the second face 60b. The first inner porous layer 83 covers the entire region from the front end of the first face 60a on which the upper connector electrodes 71a to 71d are disposed, to the first dense layer 86 (see FIGS. 2 to 4). The right-left width of the first inner porous layer 83 is the same as the right-left width of the first face 60a, and the first inner porous layer 83 covers the first face 60a from the left end to the right end thereof. The first inner porous layer 83 covers at least part of the outer electrode 64 and the lead 75b. The first inner porous layer 83 protects the outer electrode 64 and the lead 75b from, for example, the contents such as sulfuric acid in a measurement-object gas in the element chamber 33, and plays a role of reducing corrosion of these. The second inner porous layer 84 covers the entire region from the front end of the second face 60b on which the lower connector electrode 72 is disposed, to the second dense layer 87 (see FIGS. 2, 3). The second inner porous layer 84 is disposed symmetrically with the first inner porous layer 83 vertically.

The outer porous layer 85 covers the first to fifth faces 60a to 60e. The outer porous layer 85 covers the first face 60a and the second face 60b by covering the inner porous layer 81. The outer porous layer 85 has a shorter length in the front-rear direction than the inner porous layer 81, and in contrast to the inner porous layer 81, covers only the front end and the region near the front end of the element body 60. Thus, the outer porous layer 85 covers a peripheral portion of the electrodes 64 to 68 of the detection unit 63 in the element body 60, in other words, a portion of the element body 60, being exposed to the measurement-object gas disposed in the element chamber 33. Thus, the outer porous layer 85 plays a role to prevent cracking from occurring in the element body 60 due to adherence of water in the measurement-object gas thereto, for example.

The porosity of the porous layer 80 is 10% or more. The porous layer 80 covers the outer electrode 64 and the measurement-object gas inlet 61, and with the porosity of 10% or more, a measurement-object gas can pass through the porous layer 80. The porosity of the inner porous layer 81 may be 10% or more and 50% or less. The porosity of the outer porous layer 85 may be 10% or more and 85% or less. The outer porous layer 85 has a higher porosity than the inner porous layer 81.

The first dense layer 86 and the second dense layer 87 restrain the capillary phenomenon of water in the longitudinal direction of the element body 60. The first dense layer 86 is disposed on the first face 60a on which the upper connector electrode 71 and the first inner porous layer 83 are disposed. The first dense layer 86 is disposed rearward of the outer electrode 64 and forward of the first protection layer 91. The first dense layer 86 is disposed rearward of any of the plurality of electrodes 64 to 68 of the detection unit 63, including the outer electrode 64 (see FIG. 3). The first dense layer 86 is disposed at a position overlapping the insulator 44b in the front-rear direction (see FIG. 1). In other words, the region from the front end to the rear end of the first dense layer 86 is located within the region from the front end to the rear end of the insulator 44b. The first dense layer 86 plays a role to prevent passage of water therethrough to prohibit the water from reaching the upper connector electrode 71 in case water is moved rearward within the first inner porous layer 83 due to a capillary phenomenon. The first dense layer 86 is a dense layer having a porosity less than 10%. The right-left width of the first dense layer 86 is the same as the right-left width of the first face 60a, and the first dense layer 86 covers the first face 60a from the left end to the right end thereof. The first dense layer 86 is adjacent to the rear end of the first inner porous layer 83. The first dense layer 86 is disposed apart from the first protection layer 91. As illustrated in FIG. 4, the first dense layer 86 covers part of the lead 75b. A gap region is formed between the first dense layer 86 and the first protection layer 91, where the porous layer 80 and the first protection layer 91 are not provided, and the lead 75b is exposed in the gap region.

The second dense layer 87 is disposed on the second face 60b on which the lower connector electrode 72 and the second inner porous layer 84 are disposed. Since the second dense layer 87 is disposed symmetrically with the first dense layer 86 vertically, a detailed description of the arrangement of the second dense layer 87 is omitted. The second dense layer 87 plays a role to prevent passage of water therethrough to prohibit water from reaching the lower connector electrode 72 in case water is moved rearward within the second inner porous layer 84 due to a capillary phenomenon. The second dense layer 87 is a dense layer having a porosity less than 10%.

The first dense layer 86 and the second dense layer 87 each preferably have a longitudinal length of 0.5 mm or more. With the longitudinal length of 0.5 mm or more, it is possible to sufficiently prevent the passage of the water through the first dense layer 86 and the second dense layer 87. The length of the first dense layer 86 and the second dense layer 87 may be 25 mm or less, or may be 20 mm or less. Note that in this embodiment, the length of the first dense layer 86 and the length of the second dense layer 87 are the same value, however, both may be different values.

The first protection layer 91 is a member for protecting the leads 75b, 75c from the contact metal fitting 52 of the connector 50. The first protection layer 91 is disposed on the first face 60a on which the upper connector electrode 71 and the leads 75b, 75c are disposed. The first protection layer 91 covers at least part of the leads 75b, 75c formed on the first face 60a. The first protection layer 91 is disposed rearward of the first dense layer 86 and forward of the upper connector electrode 71. The first protection layer 91 is disposed rearward of the insulator 44c (see FIG. 1). The right-left width of the first protection layer 91 is the same as the right-left width of the first face 60a, and the first protection layer 91 covers the first face 60a from the left end to the right end thereof. The first protection layer 91 is adjacent to the rear end of the upper connector electrode 71 or disposed at a position slightly forward of the upper connector electrode 71. The first protection layer 91 has a porosity P1 of 20% or less. The porosity P1 is preferably 10% or less. The porosity P1 may be lower than the porosity of the porous layer 80.

The second protection layer 92 is disposed on the second face 60b on which the lower connector electrode 72 is disposed. The second protection layer 92 is disposed symmetrically with the first protection layer 91 vertically. In this embodiment, no lead is disposed on the surface of the second face 60b, thus the second protection layer 92 does not cover any lead. The second protection layer 92 plays a role to protect the second face 60b.

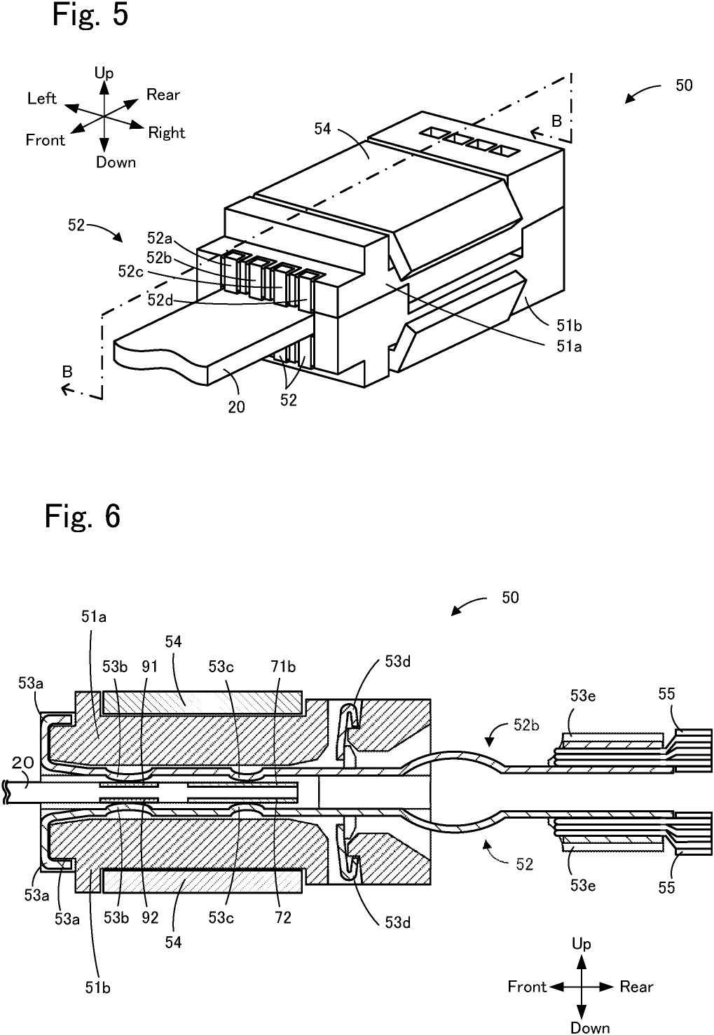

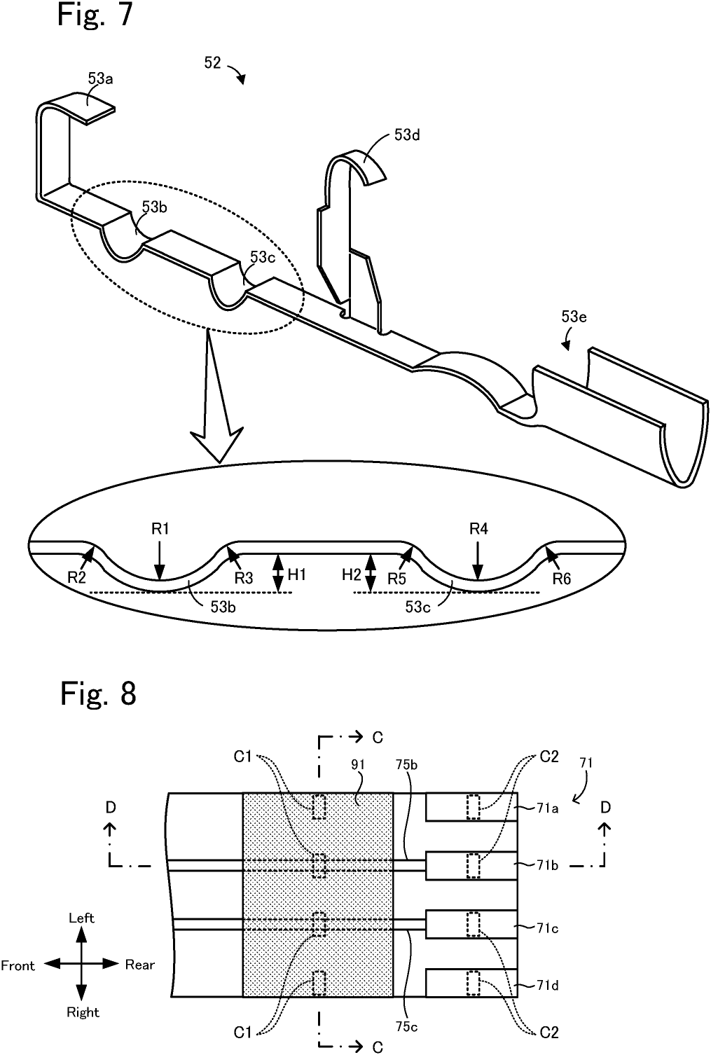

The connector 50 will be described in detail. FIG. 5 is a perspective view of the connector 50. FIG. 6 is a cross-sectional view taken along line B-B in FIG. 5. FIG. 7 is a perspective view of the contact metal fitting 52. FIG. 8 is an explanatory view illustrating contact portions C1, C2 between the sensor element 20 and the contact metal fitting 52. FIG. 6 illustrates a cross section passing through the upper connector electrode 71b of the sensor element 20. In FIG. 6, illustration of the lead 75b is omitted. FIG. 8 illustrates an enlarged view of a periphery of the first protection layer 91 in FIG. 4. The connector 50 includes a first housing 51a, a second housing 51b, the contact metal fitting 52, and a clamp 54.

The first housing 51a and the second housing 51b are members made of ceramic, such as an alumina sintered body. The first housing 51a and the second housing 51b each retain multiple (in this case, four) contact metal fittings 52 arranged in the direction (the right-left direction) perpendicular to the longitudinal direction of the sensor element 20.

Each contact metal fitting 52 is a member produced by bending a plate-like metal, for example. The contact metal fitting 52 includes a leading end 53a, a support member 53b, a conduction member 53c, a hook member 53d, and a retainer 53e. The leading end 53a and the hook member 53d have a curved shape, and these are latched in the first, second housings 51a, 51b, thus the contact metal fitting 52 is retained by the first, second housings 51a, 51b (see FIG. 6). The support member 53b and the conduction member 53c are disposed in the longitudinal direction of the contact metal fitting 52, and the conduction member 53c is disposed at a position closer to the retainer 53e than the support member 53b. Each of the support member 53b and the conduction member 53c projects to the sensor element 20 in a curved manner. The retainer 53e clamps and retains multiple core wires of the lead wires 55 outside the connector 50. The retainer 53e in FIG. 7 shows a state before clamping.

The support member 53b and the conduction member 53c of the contact metal fitting 52 are each formed to be elastically deformable, and the spring constant is in a range of 500 to 4,000 N/mm, for example. As illustrated in FIG. 7, the support member 53b projects toward the sensor element 20 only by a projection height H1. The conduction member 53c projects toward the sensor element 20 only by a projection height H2. In the conduction member 53c, the projection height H2 is preferably 90% to 110% of the projection height H1. It is preferable that the projection height H1 be closer to the projection height H2, and it is more preferable that the projection height H1 be equal to the projection height H2. Note that “the projection height H2 is equal to the projecting height H1” includes the case where the projection heights are substantially equal. The projection heights H1, H2 are not particularly limited, and are 0.1 mm to 1 mm, for example. In the support member 53b, the radius R1 of curvature of the inner peripheral surface (the upper surface of the support member 53b in FIG. 7) of the leading end in a projecting shape is, for example, 0.8 to 1.6 mm, and the radii R2, R3 of curvature of the curved outer peripheral surface (the upper surface in FIG. 7) of both shoulder portions in a projecting shape are, for example, 1.2 mm to 2.2 mm. In the conduction member 53c, the radius R4 of curvature of the inner peripheral surface (the upper surface of the conduction member 53c in FIG. 7) of the leading end in a projecting shape is, for example, 0.8 to 1.6 mm, and the radii R5, R6 of curvature of the curved outer peripheral surface (the upper surface in FIG. 7) of both shoulder portions in a projecting shape are, for example, 1.2 to 1.5 mm. Note that the radii R2, R3 of curvature may be equal, and the radii R5, R6 of curvature may be equal. Also, the radii R5, R6 of curvature may be equal to the radii R2, R3 of curvature, or may be greater than the radii R2, R3 of curvature. The projection height H1, the projection height H2, and the curvature radii R1 to R6 explained here are values with the connector 50 attached to the sensor element 20 (with the contact metal fitting 52 in contact with the sensor element 20).

A plurality of contact metal fittings 52 are retained by the first, second housings 51a, 51b so that respective conduction members 53c are opposed to the upper connector electrode 71 and the lower connector electrode 72 of the sensor element 20 in a one-to-one corresponding manner. Thus, the respective conduction members 53c of the plurality of contact metal fittings 52 are brought into contact with the opposed upper connector electrode 71 and lower connector electrode 72 to be electrically conducted thereto. Respective support members 53b of the plurality of contact metal fittings 52 are in contact with the sensor element 20 at a position forward of the upper connector electrode 71 and the lower connector electrode 72 of the sensor element 20, more specifically, are in contact with the first protection layer 91 and the second protection layer 92 of the sensor element 20. FIG. 8 shows the positions of contact portions C1 between the support members 53b and the first protection layer 91, and the positions of contact portions C2 between the conduction members 53c and the upper connector electrode 71 by dashed line frames. The positions of contact portions between the contact metal fittings 52, and the lower connector electrode 72, the second protection layer 92 are similar to those in FIG. 8, thus are not illustrated.

Of the plurality of contact metal fittings 52, those retained by the first housing 51a and in contact with the upper connector electrodes 71a to 71d are referred to as contact metal fittings 52a to 52d and distinguished (see FIG. 5). For example, the conduction member 53c of the contact metal fitting 52b is in contact with the upper connector electrode 71b at the contact portion C2 illustrated in FIG. 8, and the support member 53b of the contact metal fitting 52b is in contact with the first protection layer 91 at the contact portion C1 forward of the upper connector electrode 71b. The conduction member 53c of the contact metal fitting 52c is in contact with the upper connector electrode 71c at a contact portion C2 illustrated in FIG. 8, and the support member 53b of the contact metal fitting 52c is in contact with the first protection layer 91 at a contact portion C1 forward of the upper connector electrode 71c. As illustrated in FIG. 8, the lead 75b is provided immediately below the contact portion C1 between the support member 53b of the contact metal fitting 52b and the first protection layer 91. The lead 75c is provided immediately below the contact portion C1 between the support member 53b of the contact metal fitting 52c and the first protection layer 91.

The clamp 54 is obtained by bending a plate-like metal in a C-shaped form, and provides an elastic force capable of sandwiching and pressing the first housing 51a and the second housing 51b in a direction closer to each other. The clamp 54 holds the first housing 51a and the second housing 51b by the elastic force. In addition, the pressing force from the clamp 54 causes the support member 53b and the conduction member 53c of the contact metal fitting 52 to be elastically deformed to sandwich and fix the sensor element 20. The connector 50 can sandwich and fix the sensor element 20 by the pressing force due to the elastic deformation of the support member 53b and the conduction member 53c. Since the conduction member 53c is elastically deformed, electrical conduction between the conduction member 53c, and the upper connector electrode 71, the lower connector electrode 72 can be maintained.

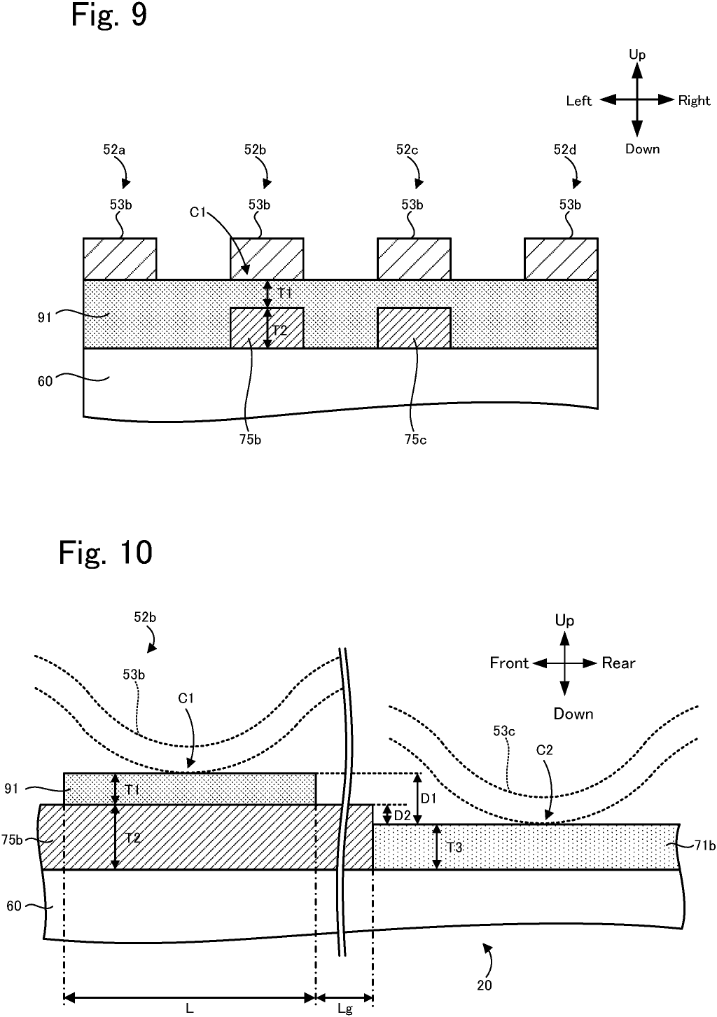

The positional relationship between the upper connector electrode 71b, the lead 75b, the first protection layer 91 and the contact metal fitting 52b will be described in detail. FIG. 9 is a partial enlarged view of a cross section along line C-C in FIG. 8. FIG. 10 is a partial enlarged view of a cross section along line D-D in FIG. 8. Note that for the convenience of description, FIG. 10 illustrates the later-described height differences D1, D2 in an exaggerated manner. As illustrated in FIGS. 9 and 10, the first protection layer 91 covers the lead 75b, so is provided between the lead 75b and the support member 53b of the contact metal fitting 52b located immediately above the lead 75b. Thus, the first protection layer 91 protects the lead 75b from the support member 53b. The thickness T1 of the portion, covering the lead 75b, of the first protection layer 91 is 2 µm or more. The thickness T1 is for the portion, immediately above the lead 75b, of the first protection layer 91. As described above, the porosity P1 of the first protection layer 91 is 20% or less. Like this, with the porosity P1 of 20% or less and the thickness T1 of 2 µm or more in the first protection layer 91 between the lead 75b and the support member 53b, it is possible to protect the lead 75b from the support member 53b to prevent wear of the lead 75b. Also, the height difference D1 (see FIG. 10) between the upper connector electrode 71b connected to the lead 75b and the first protection layer 91 is 22 µm or less. When the height difference D1 is too large, in other words, when the height (the height of the upper surface of the first protection layer 91) of the first protection layer 91 relative to the height (the height of the upper surface of the upper connector electrode 71b) of the upper connector electrode 71b is too large, contact at the contact portion C2 between the conduction member 53c of the contact metal fitting 52b and the upper connector electrode 71b may be insufficient. Consequently, a conduction failure may be likely to occur between the conduction member 53c and the upper connector electrode 71b. With the height difference D1 of 22 µm or less, the occurrence of such a conduction failure can be reduced. Based on the foregoing, in the gas sensor 10 in this embodiment, with the thickness T1 of 2 µm or more, the porosity P1 of 20% or less, and the height difference D1 of 22 µm or less in the first protection layer 91, it is possible to reduce the occurrence of a conduction failure between the upper connector electrode 71b and the contact metal fitting 52b while protecting the lead 75b from wear. For a larger thickness T1, the effect of protection of the lead 75b from wear is increased; however, the height difference D1 tends to increase for a larger thickness T1. In the gas sensor 10 in this embodiment, the above-mentioned protection from wear and reduction in the occurrence of a conduction failure are both achieved by setting the thickness T1 to 2 µm or more and the height difference D1 to 22 µm or less. The height difference D1 has a positive value when the height of the first protection layer 91 is higher than the height of the upper connector electrode 71b. In other words, the height difference D1 is a value obtained by subtracting the height of the upper connector electrode 71b from the height of the first protection layer 91. The height difference D1 may exceed 0 µm, or may be 4 µm or more.

In this embodiment, the height difference D2 (see FIG. 10) obtained by subtracting the height of the upper connector electrode 71b from the height of the lead 75b exceeds 0 µm. In other words, the height of the lead 75b is higher than the height of the upper connector electrode 71b. In this embodiment, as illustrated in FIG. 10, with the thickness T2 of the lead 75b greater than the thickness T3 of the upper connector electrode 71b, the height difference D2 exceeds 0 µm. Here, the height difference D1 is the sum of the height difference D2 and the thickness T1 of the first protection layer 91. Thus, when the height difference D2 exceeds 0 µm, in other words, has a positive value, the height difference D1 cannot be 0 µm and inevitably exceeds 0 µm (positive value). Even in this case, when the height difference D1 is 22 µm or less, due to the above-mentioned reason, it is possible to reduce the occurrence of a conduction failure between the conduction member 53c of the contact metal fitting 52b and the upper connector electrode 71b. The height difference D2 may be 2 µm or more. When the thickness T2 > the thickness T3, part of the lead 75b may cover the front end of the upper connector electrode 71b. In other words, the lead 75b and the upper connector electrode 71b may overlap in part. In this manner, the lead 75b and the upper connector electrode 71b can be conducted to each other more reliably.

The porosity P1 of the first protection layer 91 is preferably 10% or less. When the porosity P1 is 10% or less, the first protection layer 91 is dense, and wear of the first protection layer 91 itself in the contact portion C1 between the first protection layer 91 and the support member 53b is protected. Consequently, it is possible to prevent the support member 53b from coming into contact with the lead 75b due to wear of the first protection layer 91, thus protection of the lead 75b from wear is further achieved.

The thickness T1 of the first protection layer 91 may be 10 µm or more. For a larger thickness T1, the first protection layer 91 has an increased effect of protection of the lead 75b from wear. The thickness T1 may be 20 µm or less.

In the first protection layer 91, the length L (see FIGS. 4, 10) of the sensor element 20 in the longitudinal direction (in this case, the front-back direction) is preferably 2 mm or more. With the length L of 2 mm or more, even when the relative position of the first protection layer 91 with respect to the support member 53b of the contact metal fitting 52b is displaced in the longitudinal direction, the first protection layer 91 is present between the support member 53b and the lead 75b, thus the state of protected lead 75b is likely to be maintained. In other words, the position of the contact portion C1 between the sensor element 20 and the contact metal fitting 52b is unlikely to be displaced from the first protection layer 91. Thus, it is possible to protect the lead 75b from wear due to direct contact between the support member 53b and the lead 75b. The length L may be 6 mm or less. The distance Lg (see FIG. 4, FIG. 10) between the first protection layer 91 and the front end of the upper connector electrode 71 may be, for example, 0 µm or more. In this embodiment, the first protection layer 91 is disposed forward of the upper connector electrode 71, thus the distance Lg has a value greater than 0 µm.

So far, the protection of the lead 75b from wear and the reduction in the occurrence of a conduction failure between the upper connector electrode 71b and the contact metal fitting 52b have been described, and a similar description can be applied to the lead 75c and the upper connector electrode 71c. For example, when the thickness T1 of the portion, covering the lead 75c, of the first protection layer 91 is 2 µm or more, the porosity P1 of the first protection layer 91 is 20% or less, and the height difference D1 between the first protection layer 91 and the upper connector electrode 71c is 22 µm or less, it is possible to reduce the occurrence of a conduction failure between the upper connector electrode 71c and the contact metal fitting 52c while protecting the lead 75c from wear. In this manner, when multiple leads are provided to be covered by the first protection layer 91, with the above-described conditions for the thickness T1, the porosity P1, and the height difference D1 met regarding each of the leads, the connector electrode connected to the lead, and the first protection layer 91, it is possible to protect the lead from wear and reduce the occurrence of a conduction failure of the connector electrode. When multiple leads are provided to be covered by the first protection layer 91, it is sufficient that the above-described conditions for the thickness T1, the porosity P1, and the height difference D1 be met regarding at least one of the multiple leads and the connector electrode connected to the lead. For each of multiple leads covered by the first protection layer 91, it is preferable that the above-described conditions for the thickness T1, the porosity P1, and the height difference D1 be met regarding the lead and the connector electrode connected to the lead. In this embodiment, the lead 75b and the lead 75c have the same thickness, the upper connector electrode 71b and the upper connector electrode 71c have the same thickness, and the thickness T1 of the first protection layer 91 has the same value as the portion covering the lead 75b as well as the portion covering the lead 75c. Thus, in the gas sensor 10 in this embodiment, the effect of reducing the occurrence of a conduction failure between the upper connector electrode 71b and the contact metal fitting 52b while protecting the lead 75b from wear, and the effect of reducing the occurrence of a conduction failure between the upper connector electrode 71c and the contact metal fitting 52c while protecting the lead 75c from wear are both achieved.

In this embodiment, the first protection layer 91 does not cover the leads connected to the upper connector electrodes 71a, 71d, but it is preferable that the height difference between the first protection layer 91 and each of the upper connector electrodes 71a, 71d be 22 µm or less. In this setting, it is possible to reduce the occurrence of a conduction failure between the contact metal fitting 52 and the upper connector electrodes 71a, 71d. In this embodiment, the second protection layer 92 does not cover the leads, thus has nothing to do with the effect of protecting the leads from wear; however, it is preferable that the height difference between the second protection layer 92 and the lower connector electrode 72 be 22 µm or less. In this setting, it is possible to reduce the occurrence of a conduction failure between the contact metal fitting 52 and the lower connector electrodes 72.

It is preferable that the first protection layer 91 be ceramic containing ceramic particles as constituent particles, and it is more preferable that the first protection layer 91 contain at least one selected from the group of alumina, zirconia, spinel, cordierite, titania and magnesia. It is further preferable that the first protection layer 91 contain particles of at least one selected from the group of alumina and zirconia as constituent particles. In this embodiment, the first protection layer 91 is ceramic containing particles of alumina. For the porous layer 80, the first dense layer 86, the second dense layer 87, and the second protection layer 92, the same ceramic as the first protection layer 91 can be used. In this embodiment, ceramic of alumina is also used for these layers as in the first protection layer 91.

The porosity P1 of the first protection layer 91 is a value derived as follows by using an image (SEM image) obtained from observation using a scanning electron microscope (SEM). First, the sensor element 20 is cut such that a cross section of the first protection layer 91 is set as an observation surface, and an observation sample is obtained by performing a resin-embedding process and a polishing process on the cut surface. Then, a magnifying power of SEM is set to 1000 to 10000, and the observation surface of the observation sample is photographed to obtain an SEM image of the first protection layer 91. Subsequently, the obtained image is analyzed, so that a threshold value is determined using the discriminant analysis method (Otsu binarization method) from a brightness distribution of brightness data of the pixels in the image. Then, each pixel in the image is binarized into an object section and a pore section based on the determined threshold value, and the area of the object section and the area of the pore section are calculated. Then, the percentage of the area of the pore section relative to the overall area (i.e., the total area of the object section and the pore section) is derived as the porosity P [%]. The porosity P1 of each of the porous layer 80, the first dense layer 86 and the second dense layer 87 is a value derived in a similar manner.

In the same manner as for the porosity P1, the thicknesses T1 to T3, the height difference D1, and the height difference D2 are values derived as follows by using SEM images. For example, when the thicknesses T1 to T3, the height difference D1, and the height difference D2 are measured regarding the first protection layer 91, the lead 75b, and the upper connector electrode 71b, measurement is performed as follows. First, a cross section (a cross section in the longitudinal direction of the sensor element) passing through the center of the upper connector electrode 71b of the first protection layer 91 in the transverse direction (in this case, the right-left direction) of the sensor element is set as an observation surface for photographing an SEM image. Next, a region where each of the first protection layer 91, the lead 75b, and the upper connector electrode 71b exists in the obtained SEM image is identified based on brightness data of the pixels in the SEM image. Then, of the portion (the portion immediately above the lead 75b), covering the lead 75b, of the first protection layer 91 in the SEM image, three points at the center and both ends in the longitudinal direction of the sensor element are set as the measurement points to measure the thickness of the first protection layer 91, and let thickness T1 be the average value of the thicknesses at these three points. Similarly, three points at the center and both ends of the portion (the portion immediately below the first protection layer 91), covered by the first protection layer 91, of the lead 75b in the SEM image are set as the measurement points to measure the thickness of the lead 75b, and let thickness T2 be the average value of the thicknesses at these three points. Also, for the upper connector electrode 71b, let thickness T3 be the average value of the thicknesses at three points at the center and both ends in the SEM image. The height difference D2 is measured as the distance in the height direction (in this case, the up-down direction) between the average value the height position (in this case, the position of the upper surface of the lead 75b) of the lead 75b at the same measurement points as those for the thickness T2 in the SEM image, and the average value the height position (in this case, the position of the upper surface of the upper connector electrode 71b) of the upper connector electrode 71b at the same measurement points as those for the thickness T3 in the SEM image. The height difference D1 is calculated as the sum of the thickness T1 and the height difference D2.

A method for manufacturing thus configured gas sensor 10 will be described below. First, a method for manufacturing the sensor element 20 will be described. When the sensor element 20 is manufactured, multiple (in this case, six) non-calcinated ceramic green sheets corresponding the element body 60 are prepared. In each green sheet, a notch, a through-hole, and a groove are provided, and an electrode and a wiring pattern are screen-printed as necessary. The wiring pattern includes a pattern of non-calcinated leads that are to become the leads 75b, 75c after calcination. In addition, surfaces of the green sheets, corresponding to the first, second faces 60a, 60b are formed by screen printing for non-calcinated porous layers that are to become the first inner porous layer 83 and the second inner porous layer 84 after calcination, non-calcinated dense layers that are to become the first dense layer 86 and the second dense layer 87 after calcination, non-calcinated protection layers that are to become the first protection layer 91 and the second protection layer 92 after calcination, and non-calcinated connector electrodes that are to become the upper connector electrode 71 and the lower connector electrode 72 after calcination. Subsequently, a plurality of green sheets are stacked. The plurality of green sheets stacked is a non-calcinated element body that is to become the element body after calcination. Then, the non-calcinated element body is calcinated to obtain the element body 60 including the lead 75b, the lead 75c, the upper connector electrode 71, the lower connector electrode 72, the first protection layer 91, and the second protection layer 92. Subsequently, the outer porous layer 85 is formed by plasma spraying to obtain the sensor element 20.

The porosity P1 of the first protection layer 91 can be adjusted by adjusting the amount of pore-forming material contained in a corresponding non-calcinated protection layer. The thickness T1 of the first protection layer 91 can be adjusted, for example, by adjusting the amount of the solvent contained in a corresponding non-calcinated protection layer to adjust the viscosity thereof. The thickness T1 can also be adjusted by the number of times of screen printing when the non-calcinated protection layers are formed. The thickness T2 of the lead 75b and the thickness T3 of the upper connector electrode 71b can be adjusted in the same manner. The height differences D1, D2 can also be adjusted by adjusting these thicknesses T1 to T3. The length L of the first protection layer 91 can be adjusted by the shape of a mask for screen printing when the non-calcinated protection layers are formed.

Next, the gas sensor 10 having the sensor element 20 integrated therein is fabricated. First, the sensor element 20 is inserted in the cylindrical body 41 in the axial direction, and the insulator 44a, the green compact 45a, the insulator 44b, the green compact 45b, the insulator 44c, and the metal ring 46 are disposed in that order between the inner peripheral surface of the cylindrical body 41 and the sensor element 20. Next, the metal ring 46 is pressed to compress the green compacts 45a, 45b, and the reduced-diameter sections 43c, 43d are formed in this state to manufacture the element sealing unit 40 to seal between the inner peripheral surface of the cylindrical body 41 and the sensor element 20. Subsequently, the protection cover 30 is welded to the element sealing body 40, and the bolt 47 is attached thereto so that the assembly 15 is obtained.

Subsequently, multiple (in this case, eight) lead wires 55 are inserted through the rubber stopper 57, and the core wires of the lead wires 55 are surrounded and clamped by the retainer 53e of each of multiple (in this case, eight) contact metal fittings 52, thereby causing the contact metal fittings 52 and the lead wires 55 to be electrically conducted. Then, in a state where four contact metal fittings 52 are retained by each of the first housing 51a and the second housing 51b, the sensor element 20 is sandwiched by the first housing 51a and the second housing 51b, and the first housing 51a and second housing 51b are sandwiched and fixed by the clamp 54. Consequently, in each of multiple contact metal fittings 52, the support member 53b is in contact with the first protection layer 91 or the second protection layer 92, and the conduction member 53c is in contact with the upper connector electrode 71 or the lower connector electrode 72. After the connector 50 is connected to the rear-end side of the sensor element 20 in this manner, the outer cylinder 48 is welded and fixed to the main metal fitting 42 to obtain the gas sensor 10.

An example of use of thus configured gas sensor 10 will be described below. When a measurement-object gas flows through the pipe 58 with the gas sensor 10 attached to the pipe 58 as in FIG. 1, the measurement-object gas flows through the protection cover 30 to enter the element chamber 33, and the front-end side of the sensor element 20 is exposed to the measurement-object gas. When the measurement-object gas passes through the porous layer 80 to reach the outer electrode 64 as well as reach the inside of the sensor element 20 through the measurement-object gas inlet 61, as described above, detection unit 63 generates an electrical signal according to the NOx concentration in the measurement-object gas. The electrical signal is obtained through the upper, lower connector electrodes 71, 72, and the NOx concentration is detected based on the electrical signal.

The correspondence relationship between the components in this embodiment and the components in the present invention will now be clarified. The element body 60 according to this embodiment corresponds to an element body according to the present invention, the upper connector electrode 71b corresponds to a connector electrode, the lead 75b corresponds to a lead, the first protection layer 91 corresponds to a protection layer, and the contact metal fitting 52b corresponds to a contact metal fitting.

In the gas sensor 10 according to this embodiment described above in detail, with the thickness T1 of 2 µm or more, the porosity P1 of 20% or less, and the height difference D1 of 22 µm or less in the first protection layer 91, it is possible to reduce the occurrence of a conduction failure between the upper connector electrode 71b and the contact metal fitting 52b while protecting the lead 75b from wear. Note that when the lead 75b is worn, change in the resistance value of the lead 75b may cause change in an electrical signal taken from the sensor element 20, thus the accuracy of detection of a specific gas concentration may be reduced. In addition, when the lead 75b is further worn, the lead 75b may be broken. Such reduction in the accuracy of detection and breakage can be prevented by protecting the lead 75b from wear.

With the porosity P1 of 10% or less in the first protection layer 91, the effect of protection of the lead 75b from wear by the first protection layer 91 is increased.

Furthermore, the element body 60 has an elongate shape having a longitudinal direction, the support member 53b and the conduction member 53c of the contact metal fitting 52b are disposed in the longitudinal direction of the element body 60, and the first protection layer 91 has a longitudinal length L of 2 mm or more. With the length L of 2 mm or more, even when the relative position of the first protection layer 91 with respect to the support member 53b is displaced in the longitudinal direction, the first protection layer 91 is present between the support member 53b and the lead 75b, thus the state of protected lead 75b is likely to be maintained. Thus, it is possible to protect the lead 75b from wear due to direct contact between the support member 53b and the lead 75b. Examples of displacement of the relative position of the first protection layer 91 with respect to the support member 53b include, for example, a case of occurrence of a manufacturing error in the connection position of the connector 50 when connected to the sensor element 20 at the time of manufacturing the gas sensor 10, and a case of vibration of the gas sensor 10 caused by vibration of a vehicle during use of the gas sensor 10.

Furthermore, the height difference D2 obtained by subtracting the height of the upper connector electrode 71b from the height of the lead 75b exceeds 0 µm. When the height difference D2 exceeds 0 µm, in other words, when the lead 75b is greater in height than the upper connector electrode 71b, the height difference D1 is likely to increase because the first protection layer 91 is further provided on the lead 75b. Even in this case, with the height difference D1 of 22 µm or less, it is possible to reduce the occurrence of a conduction failure between the upper connector electrode 71b and the contact metal fitting 52b.

The present invention is not limited whatsoever to the above embodiment, and various embodiments are possible so long as they belong within the technical scope of the present invention.

For example, in the above embodiment, the first protection layer 91 covers the lead 75b and the lead 75c, but the configuration is not limited thereto. The first protection layer 91 may cover at least one lead. The first protection layer 91 may cover three or more leads.

In the above embodiment, the right-left width of the first protection layer 91 is the same as the right-left width of the first face 60a, however, the right-left width of the first protection layer 91 may be smaller than the right-left width of the first face 60a, provided that the first protection layer 91 covers at least one lead.

In the above embodiment, the height difference D2 exceeds 0 µm, but is not limited to thereto. The height difference D2 may be 0 µm, or less than 0 µm (negative value). For example, the thickness T2 of the lead 75b may be smaller than the thickness T3 of the upper connector electrode 71b, thus the height difference D2 may be a negative value. The height difference D2 may be -5 µm or more, or 0 µm or more. In the above embodiment, with the thickness T2 > the thickness T3, the height difference D2 is a positive value, but is not limited to thereto. For example, another layer may be present between the lead 75b and the element body 60 so that the thickness T2 < the thickness T3 and the height difference D2 is a positive value.

In the above embodiment, the height difference D1 exceeds 0 µm, but is not limited to thereto. The height difference D1 may be 0 µm, or less than 0 µm (negative value). For example, the height difference D1 can be less than 0 µm when the sum of the thickness T1 of the first protection layer 91 and the thickness T2 of the lead 75b is less than the thickness T3 of the upper connector electrode 71b. The height difference D1 may be -22 µm or more, may be -10 µm or more, or may be 0 µm or more.

In the above embodiment, the gas sensor 10 measures the NOx concentration as the specific gas concentration, however without being limited to this, the concentration of another oxide may be detected as the specific gas concentration. If the specific gas is an oxide, oxygen is produced when the specific gas itself is reduced in a periphery of the measurement electrode 67 similarly to the above embodiment, so that the specific gas concentration can be detected based on the detection value of the detection unit 63 according to the oxygen. Furthermore, the specific gas may be a non-oxide, such as ammonia. If the specific gas is a non-oxide, the specific gas is converted into an oxide (e.g., is converted into NO in the case of ammonia) in a periphery of the inner main pump electrode 65, so that oxygen is produced when the converted oxide is reduced in a periphery of the measurement electrode 67. Thus, the specific gas concentration can be detected based on the detection value of the detection unit 63 according to the oxygen. In this manner, regardless of whether the specific gas is an oxide or a non-oxide, the gas sensor 10 can detect the specific gas concentration based on the oxygen produced from the specific gas in a periphery of the measurement electrode 67.

### EXAMPLES

Specific fabrication examples of gas sensors will be described below as examples. Examples 2 to 9, 12, 13 correspond to Examples of the invention, and Experimental Examples 1, 10, 11, 14 correspond to Comparative Examples. The present invention is not limited to the following examples.

### Experimental Example 1

Experimental Example 1 is achieved by fabricating a gas sensor similar to the gas sensor 10 shown in FIGS. 1 to 10 in accordance with the above-described manufacturing method except that the first protection layer 91 is not provided. First, six ceramic green sheets are prepared, where each green sheet is obtained by mixing zirconia particles having 4 mol% of yttria added thereto as a stabilizer with an organic binder and an organic solvent, and then molding the mixture by tape molding. A pattern of electrodes is formed on each green sheet by screen printing. The pattern formed includes a pattern of non-calcinated leads that are to become the leads 75b, 75c after calcination, and a pattern of non-calcinated connector electrode that is to become the upper connector electrodes 71 after calcination. A pattern of non-calcinated leads is formed using a slurry obtained by mixing platinum particles, zirconia particles and a solvent. A pattern of non-calcinated connector electrodes is formed using a slurry obtained by mixing platinum particles, zirconia particles and a solvent. Subsequently, six green sheets are stacked and calcinated. Thus, the sensor element 20 including the leads 75b, 75c and the upper connector electrode 71 is fabricated. Subsequently, the assembly 15 having the sensor element 20 integrated therein is fabricated, and the connector 50 is connected to the sensor element 20, thereby causing the conduction member 53c of each of eight contact metal fittings 52 to be electrically conducted to the upper connector electrode 71 or the lower connector electrode 72. Subsequently, the outer cylinder 48 is welded and fixed to the main metal fitting 42 to obtain the gas sensor 10 in Experimental Example 1. The sensor element 20 in Experimental Example 1 does not include the first protection layer 91, thus the support member 53b of the contact metal fitting 52b is in direct contact with the lead 75b, and the support member 53b of the contact metal fitting 52c is in direct contact with the lead 75c. In the sensor element 20 of Experimental Example 1, the thickness T2 of the lead 75b is 12 µm, the thickness T3 of the upper connector electrode 71b is 10 µm, and the height difference D2 is 2 µm.

### Experimental Example 2

Experimental Example 2 is achieved by fabricating the gas sensor 10 shown in FIGS. 1 to 10 in accordance with the above-described manufacturing method. The gas sensor 10 of Experimental Example 2 is fabricated in accordance with the same manufacturing method as in Experimental Example 1 except that the sensor element 20 includes the first protection layer 91. When the sensor element 20 of Experimental Example 2 is fabricated, a pattern of non-calcinated protection layer that is to become the first protection layer 91 after calcination is formed using a slurry obtained by mixing material powder (alumina powder), a binder solution (polyvinyl acetal and butyl carbitol), a solvent (acetone), and a pore-forming material. In Experimental Example 2, the thickness T1 of the portion, covering the lead 75b, in the first protection layer 91 is 2 µm. The thicknesses T2, T3 are the same as in Experimental Example 1, and the height difference D1 (= T1 + D2) between the first protection layer 91 and the upper connector electrode 71b is 4 µm. The porosity P1 of the first protection layer 91 is measured by the above-described method, and 8.9% is obtained.

### Experimental Examples 3 to 14

Experimental Examples 3 to 14 are achieved by fabricating the same gas sensor 10 as in Experimental Example 2 except that the thickness T1, the porosity P1, and the height difference D1 are modified in various manners as shown in Table 1. The thicknesses T2, T3 in Experimental Examples 3 to 14 are the same as in Experimental Examples 1, 2. Therefore, in each of Experimental Examples 3 to 14, the height difference D1 is equal to the sum of thickness T1 and the height difference D2 (= 2 µm).

### Checking Wear Resistance and Conduction

For the gas sensor 10 of Experimental Examples 1 to 14, a heat and vibration test is conducted to check the wear resistance of the lead 75b and conduction between the upper connector electrode 71b and the contact metal fitting 52b. A heat and vibration test is conducted twice, and each time the test is conducted, the lead 75b is observed by an appearance photo after the test, and wear resistance is checked based on whether wear of the lead 75b is observed. Specifically, when no wear of the lead 75b is observed even after conduction of the second heat and vibration test, the wear resistance is determined to be “excellent (A)”. When no wear of the lead 75b is observed after conduction of the first heat and vibration test, but wear of the lead 75b is observed after conduction of the second heat and vibration test, the wear resistance is determined to be “good (B)”. When wear of the lead 75b is observed after conduction of the first heat and vibration test, the wear resistance is determined to be “failed (F)”. When the evaluation of wear resistance is “B”, “F”, the first protection layer 91 is worn, and the lead 75b is exposed in each case, thus wear of the lead 75b is probably caused by direct contact between the support member 53b and the lead 75b. Also, the electric potential of the upper connector electrode 71b is continued to be measured during the first heat and vibration test, and it is checked whether an instantaneous abnormal electric potential occurs due to vibration. When no instantaneous abnormal electric potential occurs, no conduction failure has occurred between the contact metal fitting 52b and the upper connector electrode 71b, thus the result of checking conduction is determined to be “excellent (A)”. When an instantaneous abnormal electric potential occurs, an instantaneous conduction failure due to vibration is assumed to have occurred between the contact metal fitting 52b and the upper connector electrode 71b, thus the result of checking conduction is determined to be “failed (F)”. The heat and vibration test are conducted with the gas sensor 10 attached to an exhaust pipe of a propane burner installed in a vibration testing machine under the following conditions.

Gas temperature: 850° C.,
Gas air ratio λ: 1.05,
Vibration condition: 50 Hz → 100 Hz →150 Hz → 250 Hz sweeping for 30 minutes,
Acceleration: 30 G, 40 G, 50 G,
Testing time: 150 hours.

The thickness T1, the porosity P1, the height difference D1, the determination results of wear resistance, and the result of checking conduction in each of Experimental Examples 1 to 14 are summarized in Table 1. Note that since the first protection layer 91 is not provided in Experimental Example 1, the values of the porosity P1 and the height difference D1 are denoted as “-” (no value).

TABLE 1

| | Thickness T1 [µm] | Porosity P1 [%] | Height difference D1 [µ m] | Wear resistance | Result of checking conduction |
|---|---|---|---|---|---|
| Experimental Examples 1 | 0 | - | - | F | A |
| Experimental Examples 2 | 2 | 8.9 | 4 | A | A |
| Experimental Examples 3 | 3 | 8.9 | 5 | A | A |
| Experimental Examples 4 | 5 | 8.9 | 7 | A | A |
| Experimental Examples 5 | 7 | 8.9 | 9 | A | A |
| Experimental Examples 6 | 10 | 8.9 | 12 | A | A |
| Experimental Examples 7 | 10 | 10 | 12 | A | A |
| Experimental Examples 8 | 10 | 15 | 12 | B | A |
| Experimental Examples 9 | 10 | 20 | 12 | B | A |
| Experimental Examples 10 | 10 | 25 | 12 | F | A |
| Experimental Examples 11 | 10 | 30 | 12 | F | A |
| Experimental Examples 12 | 15 | 8.9 | 17 | A | A |
| Experimental Examples 13 | 20 | 8.9 | 22 | A | A |
| Experimental Examples 14 | 25 | 8.9 | 27 | A | F |

As seen from Table 1, in each of Experimental Examples 2 to 9, 12 to 14, in which the thickness T1 of the portion, covering the lead 75b, of the first protection layer 91 is 2 µm or more, and the porosity P1 of the first protection layer 91 is 20% or less, the evaluation of wear resistance is “excellent (A)” or “good (B)”. In contrast, in Experimental Example 1 in which the thickness T1 is less than 2 µm, and in Experimental Examples 10, 11 in which the porosity P1 exceeds 20%, the evaluation of wear resistance is “failed (F)”. From these results, it has been verified that with the thickness T1 of 2 µm or more and the porosity P1 of 20% or less, it is possible to protect the lead 75b from wear.

Of Experimental Examples 2 to 9, 12 to 14, in Experimental Examples 2 to 7, 12 to 14 in which the porosity P1 is 10% or less, the evaluation of wear resistance is “excellent (A)”, and in Experimental Examples 8, 9 in which the porosity P1 is 10% or more and 20% or less, the evaluation of wear resistance is “good (B)”. From these results, it has been verified that with the porosity P1 of 10% or less, the first protection layer 91 has an increased effect of protection of the lead 75b from wear.

In each of Experimental Examples 2 to 13 in which the height difference D1 is 22 µm or less, the result of checking conduction is “excellent (A)”. In contrast, in Experimental Examples 14 in which the height difference D1 exceeds 22 µm, the result of checking conduction is “failed (F)”. From these results, it has been verified that with the height difference D1 of 22 µm or less, it is possible to reduce the occurrence of a conduction failure between the upper connector electrode 71b and the contact metal fitting 52b. Also, in Experimental Example 1 in which the first protection layer 91 is not provided, the result of checking conduction is “excellent (A)”. This is probably because the first protection layer 91 is not provided and the height difference D2 is 2 µm which is a small value. However, as mentioned above, since the first protection layer 91 is not provided in Experimental Example 1, the evaluation of wear resistance is “failed (F)”.

From these results, it has been verified that in Experimental Examples 2 to 9, 12, 13 in which the thickness T1 is 2 µm or more, the porosity P1 is 20% or less, and the height difference D1 is 22 µm or less, it is possible to reduce the occurrence of a conduction failure between the upper connector electrode 71b and the contact metal fitting 52b while protecting the lead 75b from wear.

What is claimed is:

1. A gas sensor that detects a specific gas concentration in a measurement-object gas, the gas sensor comprising:
a sensor element including:
an element body having an oxygen-ion-conductive solid electrolyte layer,
a connector electrode disposed outside the element body,
a lead disposed outside the element body and electrically conductive to the connector electrode, and
a protection layer that covers the lead, wherein a thickness T1 of a portion covering the lead is 2 µm or more, a porosity P1 is 20% or less, and a height difference D1 relative to the connector electrode is 22 µm or less; and
a contact metal fitting including:
a conduction member that projects to the connector electrode and is in contact with and electrically conducted to the connector electrode, and
a support member that projects toward the lead and is in contact with the protection layer.

2. The gas sensor according to claim 1,
wherein the porosity P1 of the protection layer is 10% or less.

3. The gas sensor according to claim 1,
wherein the element body has an elongate shape having a longitudinal direction,
the conduction member and the support member of the contact metal fitting are disposed in the longitudinal direction, and
the protection layer has a length L of 2 mm or more in the longitudinal direction.

4. The gas sensor according to claim 1,
wherein a height difference D2 obtained by subtracting a height of the connector electrode from a height of the lead exceeds 0 µm.

5. The gas sensor according to claim 1,
wherein the height difference D1 is 4 µm or more.

6. The gas sensor according to claim 1,
wherein the protection layer is ceramic containing particles of at least one selected from the group of alumina and zirconia.

7. A sensor element for detecting a specific gas concentration in a measurement-object gas, the sensor element comprising:
an element body having an oxygen-ion-conductive solid electrolyte layer;
a connector electrode disposed outside the element body;
a lead disposed outside the element body and electrically conductive to the connector electrode; and
a protection layer that covers the lead, wherein a thickness T1 of a portion covering the lead is 2 µm or more, a porosity P1 is 20% or less, and a height difference D1 relative to the connector electrode is 22 µm or less.

8. The gas sensor according to claim 2,
wherein the element body has an elongate shape having a longitudinal direction,
the conduction member and the support member of the contact metal fitting are disposed in the longitudinal direction, and
the protection layer has a length L of 2 mm or more in the longitudinal direction.

9. The gas sensor according to claim 2,
wherein a height difference D2 obtained by subtracting a height of the connector electrode from a height of the lead exceeds 0 µm.

10. The gas sensor according to claim 3,
wherein a height difference D2 obtained by subtracting a height of the connector electrode from a height of the lead exceeds 0 µm.

11. The gas sensor according to claim 2,
wherein the height difference D1 is 4 µm or more.

12. The gas sensor according to claim 3,
wherein the height difference D1 is 4 µm or more.

13. The gas sensor according to claim 4,
wherein the height difference D1 is 4 µm or more.
